(19) United States
(12) Patent Application Publication
(10) Pub. No.: US 2004/0011589 A1
(43) Pub. Date: Jan. 22, 2004

(54) Rescue system for high-rise buildings

(76) Inventor: Eliyahu Nir, Netania (IL)

Correspondence Address: G.E. Ehrlich, Antonio Castorina, 2001 Jefferson Davis Highway, Suite 207, Arlington, VA, 22202, US

(21) Appl. No.: 10/415,499

(22) PCT Filed: Nov. 5, 2001
(86) PCT No.: PCT/IL01/01021

(30) Foreign Application Priority Data
Nov. 8, 2000 (IL) 139549

(51) Int. Cl. A62B 1/06

(52) U.S. Cl. 182/70

(57) ABSTRACT

A system for use in conjunction with emergency rescue sleeves that are mechanically deployed along at least a pair of supporting cables taught between a compacted sleeve storage compartment located at a designated story of a building and an anchor located at a point elsewhere below. The system provides for the slideable extraction of the compacted sleeve storage compartment (150), from the outer wall (110a) of a building (110) at the designated escape story, and the parallel and diagonal deployment of the rescue sleeve (112) alongside same exterior wall (110a) of the building (110).

### FIELD OF THE INVENTION

The present invention relates to rescue systems for evacuating individuals trapped in high rise buildings in case of emergency situations such as fire or earthquake of the type disclosed in PCT/IL00/00477 Patent Application published as WO 01/62138 on Aug. 30, 2001 (hereinafter called “the WO Patent”), the contents of which being hereby incorporated by reference.

### BACKGROUND OF THE INVENTION

As clearly follows in light of the description contained in the WO Patent, it has been relied upon that the rescue sleeve, ejected from its storage compartment, becomes unfolded along at least two guiding and supporting cables which are anchored to stationary object(s) located at the ground (street) level, in front of the building in question.

This, however, may not always be practicable due, among other reasons, to the particular environmental conditions prevailing in the immediate surrounding of the building. This is particularly true since a certain minimum distance between the building and the anchoring point must be preserved in order to attain a suitable inclination angle of the sleeve (say 45°), which distance enlarges in proportion to the height of the story from which the evacuation is requested.

It is therefore the prime object of the present invention to overcome this pre-requisite of the WO Patent system.

It is a further object of the invention to provide a rescue sleeve that will be deployed sidewise, parallel to and diagonally along-side a building wall.

### SUMMARY OF THE INVENTION

Thus provided according to the invention is a system for the evacuation of individuals trapped in multiple story buildings by gliding down a rescue sleeve, comprising: a sleeve made of sections, each section being made of a sheet material strengthened by a circumferential support member, the sections being connected to each other to form a continuous envelope; at least a pair of cables thread along the sleeve, one at the bottom and one at the top generatrix thereof; a pair of winch systems for winding the cables into a dedicated location at the building story from which rescue is requested, so that the sleeve becomes folded into a compact package within a storage compartment; coil spring operated means for selectively ejecting and unfolding the sleeve down to ground level where it becomes tied to stationary object(s), characterized in that the axis of the storage compartment extends in parallel to the building wall, the compartment being slidably mounted enabling its extraction outside the building so that unfolding the sleeve down to ground level is directed in parallel to and diagonally alongside the exterior wall of the building.

### BRIEF DESCRIPTION OF THE DRAWINGS

Further constructional features and advantages of the invention will be more clearly understood in the light of the ensuing description of a preferred embodiment thereof, given by way of example only, with reference to the accompanying drawings, wherein-

FIG. 1 is a schematic perspective view of the rescue system in the sleeve deployed, operative position enabled according to the present invention;

FIG. 2 is a partly sectional view of the sleeve-storage compartment taken along line II-II of FIG. 3;

FIG. 3 is a sectional view taken along line III-III of FIG. 2;

FIG. 4 is a view taken along line IV-IV of FIG. 2; and

FIG. 5 shows the sleeve-storage compartment in its out-doors extracted, ready to activate position.

### DETAILED DESCRIPTION OF THE PREFERRED EMBODIMENT

In the attached drawings, numerals with the prefix “1” will be used to designate parts and components corresponding to those of WO Patent; other parts will bear “2” as a prefix.

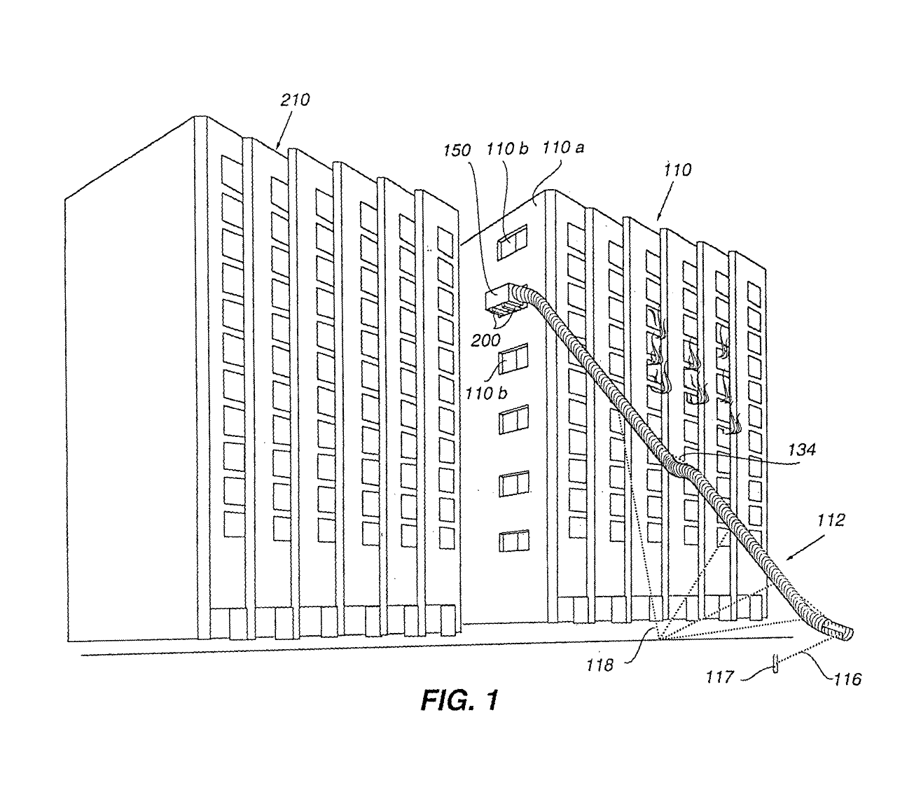

As seen in FIG. 1, there exists a second building 210 in front of a rescue exit 110b of the building 110. Therefore, the deployment of the sleeve 112 straight ahead is obstructed and only possible side-wise, in one or the other directions parallel to the wall 110a.

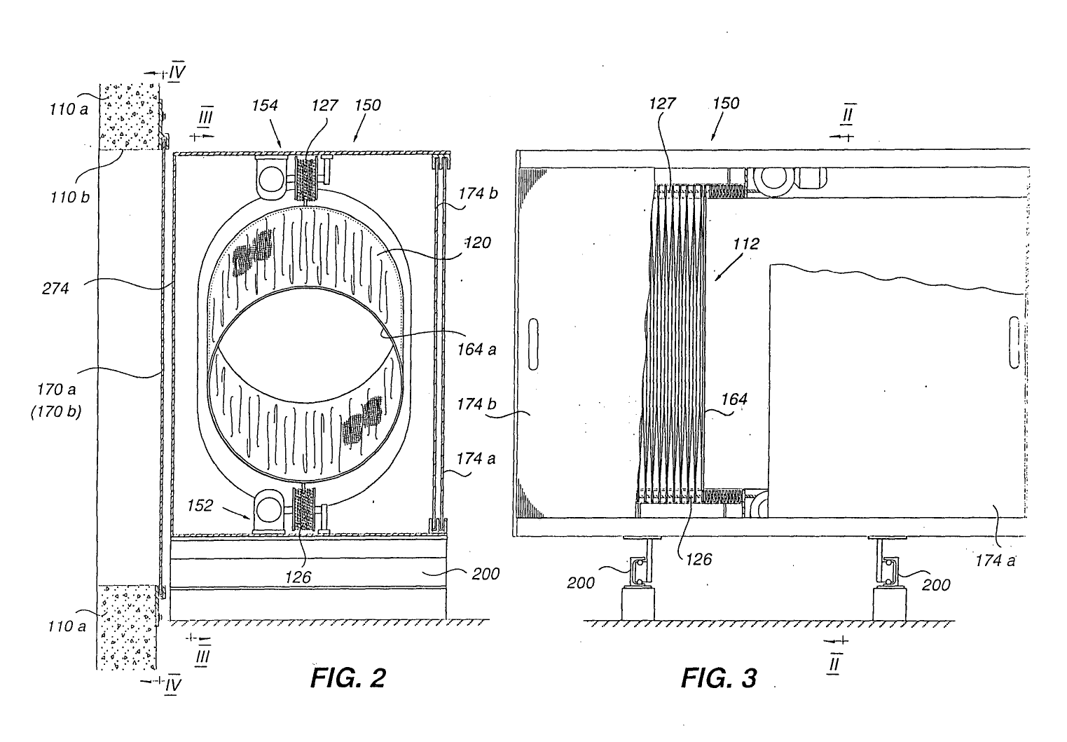

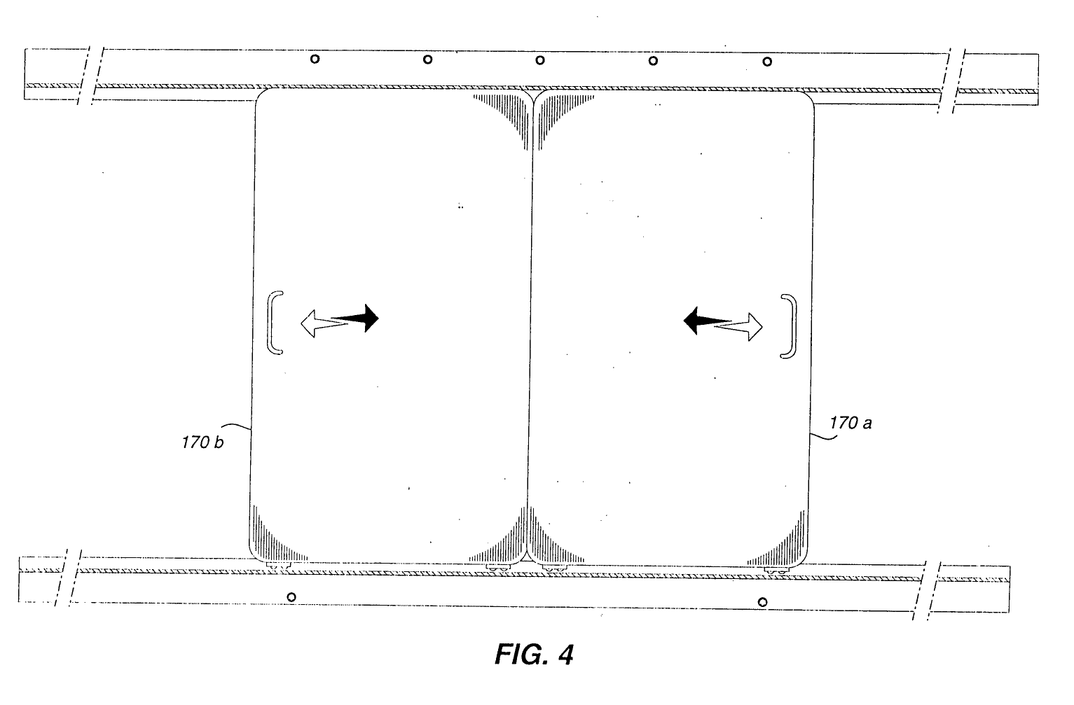

FIGS. 2 and 3 do not materially differ from those of the WO Patent. However, rather than extending normal to the building wall 110a, (as seen in FIG. 8 of the WO Patent), the compartment 150 is parallel to the wall; the single slide door 70 leading to the wall exit opening 110b is replaced by a pair of doors 170a and 170b (see FIG. 4); and the door 74b now forms a side wall 274 of the compartment 150.

The complete structure of the compartment 150 is mounted to and slides along a pair (or more) of preferably self-supporting rail systems 200 of any conventional design (FIG. 3).

Entrance doors 174a and 174b (see FIG. 3) are now provided, extending perpendicular to the building wall 110a, so that the users, after entering the compartment 150, must turn left (in the present example) in order to let him/herself into the opening 164a of rescue sleeve 112.

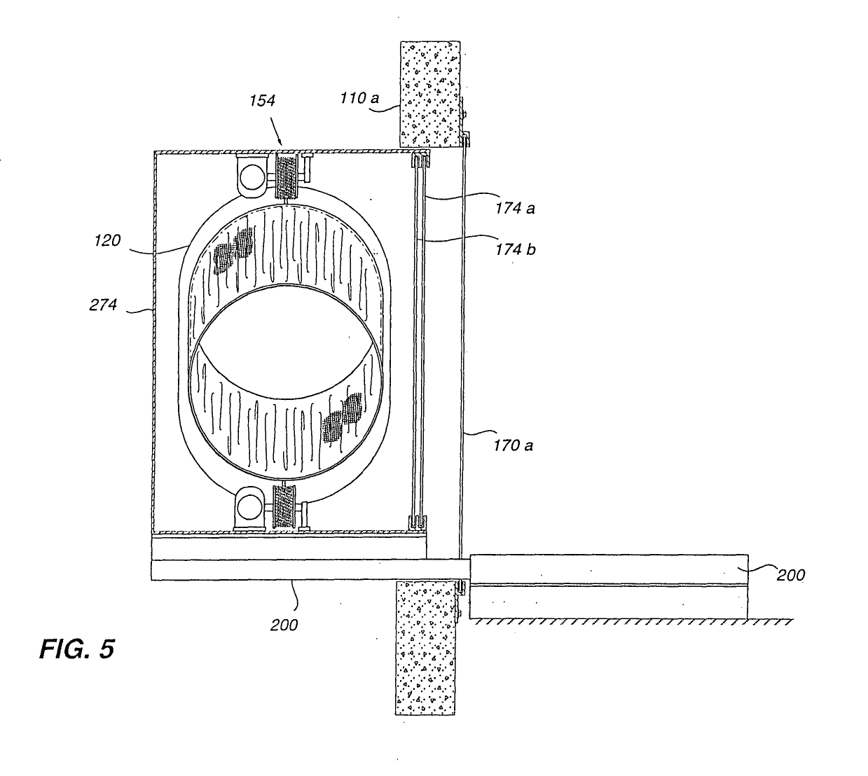

The operation of the rescue system remains the same (FIG. 1) after the compartment 150 as a whole has been pushed on the rail systems 200 out of the building wall 110a as seen in FIG. 5.

The foregoing example has been shown as a left-hand side directed unit, but the same design principles are of course applicable with respect to oppositely directed rescue system.

Various changes and modifications of the invention will be apparent.

What is claimed is:

1. A system for the evacuation of individuals trapped in multiple story buildings by gliding down a rescue sleeve, comprising: a sleeve (112) made of sections, each section being made of a sheet material strengthened by a circumferential support member, the sections being connected to each other to form a continuous envelope; at least a pair of cables (126; 127) thread along the sleeve, one at the bottom and one at the top generatrix thereof; a pair of winch systems (152; 154) for winding the cables into a dedicated location at the building story from which rescue is requested, so that the sleeve (112) becomes folded into a compact package within a storage compartment (150); coil spring operated means (160; 162) for selectively ejecting and unfolding the sleeve down to ground level where it becomes tied to stationary object(s), characterized in that the axis of the storage compartment (150) extends in parallel to the building wall (110a), the compartment being slidably mounted enabling its extraction outside the building so that unfolding the sleeve (112) down to ground level is directed in parallel to and diagonally alongside the exterior wall (110a) of the building (110).

2. The system as claimed in claim 1 wherein the compartment (150) is mounted on rails (200).

3. The system as claimed in claim 2 wherein the rails (200) are of the self-supporting type.
